(19) United States
(12) Patent Application Publication
(10) Pub. No.: US 2026/0162679 A1
(43) Pub. Date: Jun. 11, 2026

(54) METHOD

(71) Applicant: TOYOTA JIDOSHA KABUSHIKI KAISHA, Toyota-shi (JP)

(72) Inventors: Yukiko SONOHARA, Obu-shi (JP); Hirofumi MORISHITA, Anjo-shi (JP)

(73) Assignee: TOYOTA JIDOSHA KABUSHIKI KAISHA, Toyota-shi (JP)

(21) Appl. No.: 19/368,064

(22) Filed: Oct. 24, 2025

(30) Foreign Application Priority Data
Oct. 28, 2024 (JP) 2024-189211

(51) Int. Cl. G11B 20/10; G06Q 30/01; G06V 40/10

(52) U.S. Cl. CPC G11B 20/10527; G06Q 30/01; G06V 40/103

(57) ABSTRACT

A method executed by a terminal apparatus that includes a controller, an imager, and an input interface includes executing, by the controller, operations including acquiring consent from a customer regarding recording of customer engagement audio via the input interface, starting audio recording after the consent is acquired, and ending the audio recording in a case in which a predetermined condition is met.

### CROSS-REFERENCE TO RELATED APPLICATION

This application claims priority to Japanese Patent Application No. 2024-189211 filed on Oct. 28, 2024, the entire contents of which are incorporated herein by reference.

### TECHNICAL FIELD

The present disclosure relates to a method.

### BACKGROUND

Technology for analyzing dialogue content is known. For example, Patent Literature (PTL) 1 discloses a dialogue analysis system that records dialogue data based on audio data of recorded dialogue content and extracts dialogues that match conditions specified by the user from the dialogue data to display a list thereof.

### CITATION LIST

### Patent Literature

PTL 1: JP 2019-028910 A

### SUMMARY

Store staff record audio during customer engagement and utilize the recorded audio for purposes such as creating customer reports. However, the staff may forget to perform the operation to end the audio recording due to concentrating on the customer engagement.

It would be helpful to improve technology for analyzing dialogue content.

A method according to an embodiment of the present disclosure is a method executed by a terminal apparatus that includes a controller, an imager, and an input interface, the method including executing, by the controller, operations including:
acquiring consent from a customer regarding recording of customer engagement audio via the input interface;
starting audio recording after the consent is acquired;
detecting a staff member from an image of the imager; and
ending the audio recording in a case in which a predetermined condition is met.

According to an embodiment of the present disclosure, technology for analyzing dialogue content is improved.

### BRIEF DESCRIPTION OF THE DRAWINGS

In the accompanying drawings:

FIG. 1 is a block diagram illustrating a schematic configuration of a system according to an embodiment of the present disclosure; and

FIG. 2 is a flowchart illustrating operations of a terminal apparatus according to an embodiment of the present disclosure.

### DETAILED DESCRIPTION

Embodiments of the present disclosure will be described below, with reference to the drawings.

### Outline of Present Embodiment

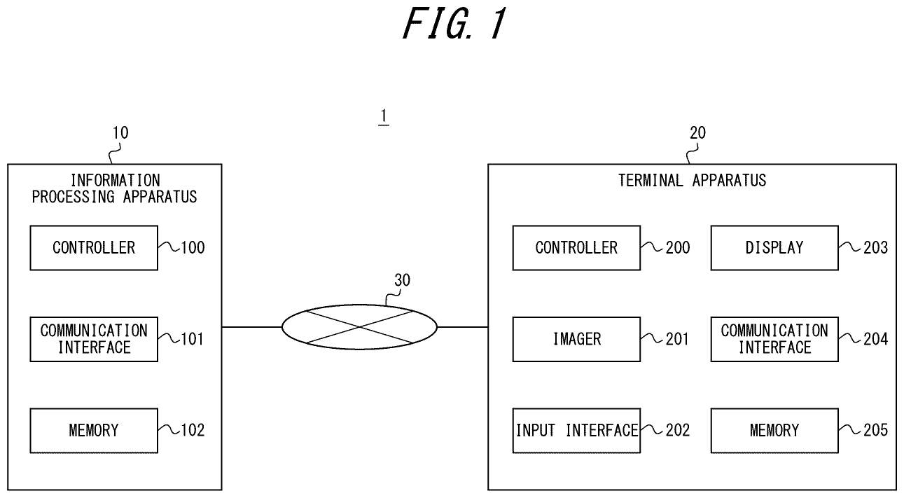

An outline of a system 1 according to the embodiment of the present disclosure will be described with reference to FIG. 1. In the present embodiment, the system 1 includes an information processing apparatus 10 and a terminal apparatus 20. The information processing apparatus 10 and the terminal apparatus 20 are communicably connected through a network 30 such as the Internet or mobile communication.

In the present embodiment, the information processing apparatus 10 includes one or multiple computers that can communicate with each other, such as a server apparatus.

In the present embodiment, the terminal apparatus 20 is a computer such as a laptop computer, tablet, or smartphone. The terminal apparatus 20 is used, for example, by staff in a store. The terminal apparatus 20 is capable of recording the voices of customers and staff.

First, an outline of the present embodiment will be described, and details thereof will be described later. The method according to the present embodiment is executed by the terminal apparatus 20, which includes a controller 200, an imager 201, and an input interface 202. The controller 200 acquires consent from a customer regarding recording of customer engagement audio via the input interface 202. The controller 200 starts audio recording after the consent is acquired. The controller 200 detects a staff member from the images of the imager 201. The controller 200 ends the audio recording in a case in which a predetermined condition is met.

According to the present embodiment, if a predetermined condition is met, the recording is automatically ended. This ensures that the recording will definitely end without the staff having to perform an end operation.

### (Configuration of Information Processing Apparatus 10)

As illustrated in FIG. 1, the information processing apparatus 10 includes a controller 100, a communication interface 101, and a memory 102.

The controller 100 includes at least one processor, at least one programmable circuit, at least one dedicated circuit, or a combination of these. The processor is, for example, a general purpose processor such as a central processing unit (CPU) or a graphics processing unit (GPU), or a dedicated processor that is dedicated to specific processing, but is not limited to these. The programmable circuit is a field-programmable gate array (FPGA), for example, but is not limited to this. The dedicated circuit is an application specific integrated circuit (ASIC), for example, but is not limited to this. The controller 100 executes various processes related to the operations of the information processing apparatus 10 while controlling the components of the information processing apparatus 10.

The communication interface 101 includes at least one interface for communication for connecting to the network 30. The communication interface is compliant with mobile communication standards such as the 4th generation (4G) standard and the 5th generation (5G) standard, or wired local area network (LAN) communication standards or wireless LAN communication standards, for example, but is not limited to these and may be compliant with any communication standard.

The memory 102 includes one or more memories. Various memories included in the memory 102 may function as, for example, a main memory, an auxiliary memory, or a cache memory. The memory 102 stores any information to be used for operations of the information processing apparatus 10. The memory 102 may store, for example, a system program, an application program, and embedded software. The memory 102 may store any data related to customer engagement such as sales talks. The information stored in the memory 102 may be updated based on information acquired from the network 30 via the communication interface 101, for example.

### (Configuration of Terminal Apparatus 20)

As illustrated in FIG. 1, the terminal apparatus 20 includes a controller 200, an imager 201, an input interface 202, a display 203, a communication interface 204, and a memory 205.

The controller 200 includes at least one processor, at least one programmable circuit, at least one dedicated circuit, or a combination of these. The processor is a general purpose processor such as a CPU or a GPU, or a dedicated processor that is dedicated to specific processing, for example, but is not limited to these. The programmable circuit is an FPGA, for example, but is not limited to this. The dedicated circuit is an ASIC, for example, but is not limited to this. The controller 200 executes various processes related to the operation of the terminal apparatus 20 and controls each part of the terminal apparatus 20.

The imager 201 includes any imaging module capable of capturing the surroundings of the terminal apparatus 20. The imaging module includes one or more cameras. Each camera is arranged at a suitable position of the terminal apparatus 20 so that it can capture the surroundings of the terminal apparatus 20. In this embodiment, the imager 201 includes an inward-facing camera capable of capturing subjects on the user side of the terminal apparatus 20 (for example, staff). The imager 201 may further include an outward-facing camera capable of capturing subjects on the opposite side of the user (for example, customers).

The input interface 202 includes one or more input interfaces. The input interface includes a microphone for receiving voice input from customers and staff. The input interface may include, for example, a physical key, a capacitive key, a pointing device, or a touch screen integrally provided with the display of display 203. The input interface 202 accepts an operation for inputting information to be used for the operations of the terminal apparatus 20. The input interface 202 may be connected to the terminal apparatus 20 as an external input device, instead of being included in the terminal apparatus 20. As a connection method, any method such as Universal Serial Bus (USB), High-Definition Multimedia Interface (HDMI®) (HDMI is a registered trademark in Japan, other countries, or both), or Bluetooth® (Bluetooth is a registered trademark in Japan, other countries, or both) can be used.

The display 203 includes at least one interface for output. The interface for output is, for example, a display that presents information as images. The display is, for example, an LCD or an organic EL display. The display 203 displays information obtained by the operations of the terminal apparatus 20. The display 203 may be connected to the terminal apparatus 20 as an external display device, instead of being included in the terminal apparatus 20. As a connection method, any method such as USB, HDMI®, or Bluetooth® can be used.

The communication interface 204 includes at least one interface for communication for connecting to the network 30. The interface for communication is compliant with, for example, mobile communication standards such as 4G or 5G, or wired LAN or wireless LAN communication standards, but is not limited to these and may be compliant with any communication standard.

The memory 205 includes one or more memories. The memories included in the memory 205 may each function as, for example, a main memory, an auxiliary memory, or a cache memory. The memory 205 stores any information to be used for operations of the terminal apparatus 20. The memory 205 may store, for example, a system program, an application program, and embedded software. The memory 205 may store any data related to customer engagement, such as sales talks. The information stored in the memory 205 may be updated based on information acquired from the network 30 via the communication interface 204.

### (Flow of Operations of Terminal Apparatus 20)

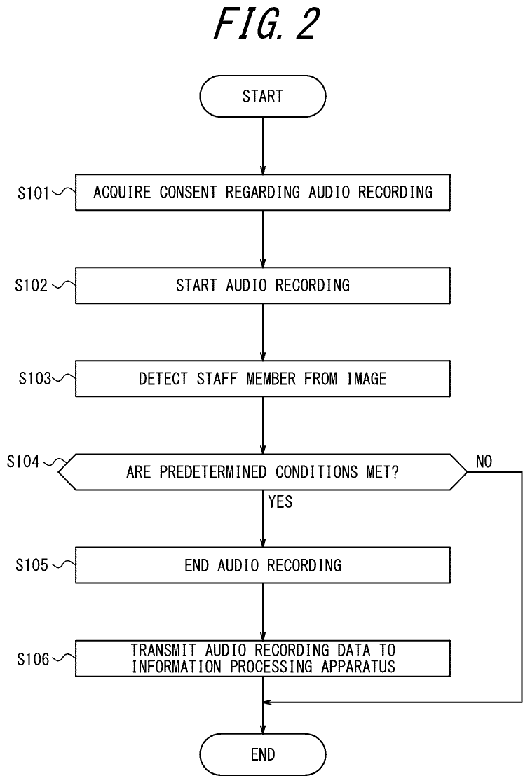

Operations of the terminal apparatus 20 according to the present embodiment will be described with reference to FIG. 2. Hereinafter, communication between the information processing apparatus 10 and the terminal apparatus 20 is performed via the communication interfaces 101, 204 and the network 30.

S101: The controller 200 of the terminal apparatus 20 acquires consent from a customer regarding recording of customer engagement audio through the input interface 202.

In this embodiment, the controller 200 acquires consent by detecting a consent phrase that suggests consent regarding recording from the utterance input to the input interface 202 (for example, a microphone). The controller 200 may detect the consent phrase by comparing it with phrases stored in the memory 102 or 205 and the content of the utterance. The comparison may utilize natural language processing techniques such as morphological analysis, syntactic analysis, semantic analysis, contextual analysis, and co-reference analysis, along with a learning model trained in advance by machine learning. The learning model may be trained to take the content of the utterance as input and output the comparison results with phrases stored in the memory 205. The features of the learning model may be specific words or phrases, such as “recording” or “consent.”

The consent phrase may include phrases indicating consent to recording of customer engagement audio, such as “I consent to the recording of customer engagement audio.” The consent phrase may include staff questions regarding consent and the customer's responses to those questions, such as “Do you consent to the recording of customer engagement audio?” and “Yes.” The consent phrase is not limited to the above examples and may include any phrase.

The controller 200 may display the question on the display 203 to prompt the staff to utter the question. This ensures that even if the staff forgets to ask the question or forgets the content of the question, they can reliably ask the question regarding consent and securely obtain consent.

The controller 200 may acquire consent by obtaining the customer's signature input on the input interface 202 (for example, a touch screen). Alternatively, the controller 200 may display a screen requesting consent on the display 203 of the terminal apparatus 20 and acquire consent by accepting the selection of consent through the input interface 202 (for example, selecting a button indicating consent).

S102: The controller 200 starts recording after the consent is acquired.

Specifically, the controller 200 records the voices of the staff and the customer input to the microphone of the input interface 202.

S103: The controller 200 detects the staff from the images of the imager 201.

The image may be captured by the front camera of the imager 201, for example. Alternatively, the controller 200 may detect the customer from the images of the imager 201. The image may be captured by the imager 201, for example, the rear camera. The controller 200 may detect staff or customers from the image using any object detection technology such as You Only Look Once (YOLO) and a convolutional neural network (CNN).

S104: The controller 200 determines whether the predetermined condition is met. If the predetermined condition is met (S104—YES), the process proceeds to S105. If the predetermined condition is not met (S104—NO), the process ends.

In this embodiment, the predetermined condition includes a first condition where an end phrase suggesting the end of customer engagement is detected from the utterance input to the input interface 202, and the staff has disappeared from the image of the imager 201 (for example, the front camera). If the controller 200 is detecting customers from the image in S103, alternatively, the first condition may be a condition where an end phrase is detected from the utterance input to the input interface 202, and the customer has disappeared from the image of the imager 201 (for example, the rear camera). The controller 200 may detect the disappearance of staff or customers from the image using any object detection technology such as YOLO and CNN.

The end phrase may be pre-stored in the memory 102 or 205. The controller 200 may detect the end phrase by comparing the phrase stored in the memory 102 or 205 with the content of the utterance. The comparison may utilize natural language processing such as morphological analysis, syntactic analysis, semantic analysis, contextual analysis, and co-reference analysis, along with a learning model trained in advance by machine learning. The learning model may be trained, for example, to take the content of the utterance as input and output the comparison result with the phrases stored in the memory 102 or 205. The features of the learning model may include specific words or phrases, such as expressions of gratitude like “Thank you for today” or farewell greetings like “I look forward to seeing you again.”

The end phrase may include phrases that are likely to be spoken by staff at the end of customer engagement, such as expressions of gratitude like “Thank you for today” or farewell greetings like “I look forward to seeing you again.” By setting such phrases as end phrases, recording can be reliably completed even if the staff forgets to perform the end operation. The end phrase is not limited to the above examples and may include any phrase.

The controller 200 may display the end phrase on the display 203 to prompt the staff to utter the end phrase. This ensures that even if the staff forgets to say the end phrase or forgets the content of the end phrase, they can reliably speak the end phrase and execute the end operation.

The predetermined condition may include a second condition where, in addition to or instead of the first condition, the utterances of staff and customers are not detected through the input interface 202 and a certain period of time has elapsed without detecting staff from the image of the imager 201. A certain period of time is, for example, 10 seconds. The process may proceed to S105 when the first condition and the second condition, or only the second condition, are satisfied.

S105: The controller 200 ends the audio recording.

S106: The controller 200 sends the generated audio recording data to the information processing apparatus 10. The process then ends.

The information processing apparatus 10 stores the audio recording data in the memory 102.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or divided.

For example, in the above embodiment, an embodiment in which the configurations and operations of the information processing apparatus 10 and the terminal apparatus 20 are distributed to multiple computers capable of communicating with each other can also be implemented.

In the above embodiment, the controller 200 may interrupt the recording before ending it. In the above embodiment, the first condition was used as the condition for ending the recording, but the first condition may also be used as the condition for interrupting the recording. Specifically, the controller 200 may interrupt the recording when the first condition is satisfied. In this case, the predetermined condition may include the above second condition.

1. A method executed by a terminal apparatus that includes a controller, an imager, and an input interface, the method comprising executing, by the controller, operations including:
acquiring consent from a customer regarding recording of customer engagement audio via the input interface;
starting audio recording after the consent is acquired;
detecting a staff member from an image of the imager; and
ending the audio recording in a case in which a predetermined condition is met.

2. The method according to claim 1, wherein the predetermined condition includes a first condition that an end phrase suggesting ending the customer engagement has been detected from an utterance input to the input interface, and that the staff member has disappeared from the image of the imager.

3. The method according to claim 2, wherein the predetermined condition further includes a second condition that a certain period of time has elapsed while an utterance of the staff member or the customer is not detected via the input interface and the staff member is not detected from the image of the imager.

4. The method according to claim 1, wherein
the operations further include interrupting the audio recording in a case in which a first condition that an end phrase suggesting ending the customer engagement has been detected from an utterance input to the input interface and that the staff member has disappeared from the image of the imager is met, and
the predetermined condition includes a second condition that a certain period of time has elapsed while an utterance of the staff member or the customer is not detected via the input interface and the staff member is not detected from the image of the imager has elapsed.

5. The method according to claim 1, wherein the operations further include transmitting generated audio recording data to an information processing apparatus.

6. The method according to claim 2, wherein the operations further include transmitting generated audio recording data to an information processing apparatus.

7. The method according to claim 3, wherein the operations further include transmitting generated audio recording data to an information processing apparatus.

8. The method according to claim 4, wherein the operations further include transmitting generated audio recording data to an information processing apparatus.
